(19) United States
(12) Patent Application Publication
(10) Pub. No.: US 2008/0243612 A1
(43) Pub. Date: Oct. 2, 2008

(54) System and method for using a browser extension to detect events related to digital advertisements

(75) Inventor: Tomi Blinnikka, Berkeley, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/729,697

(22) Filed: Mar. 29, 2007

(51) Int. Cl. G06Q 30/00

(52) U.S. Cl. 705/14; 714/48

(57) ABSTRACT

Systems and methods for detecting events related to a digital ad are disclosed. Generally, a browser extension such as a toolbar running in conjunction with a primary application, such as an Internet browser, detects an event related to a digital ad. The event may be an Internet browser receiving one or more digital ads; one or more CSC beacon requests being sent from an Internet browser to an ad provider; a user navigation event such as a user clicking on a hyperlink associated with a digital ad or activating a digital ad; or any other event or action occurring within the Internet browser and/or browser extension. The browser extension determines the validity of the detected event and communicates an indication of the determined validity of the detected event to an online advertisement service provider.

### BACKGROUND

Online advertisement service providers (“ad providers”) conventionally record a digital ad, such as a graphical banner ad, as being viewed (also known as an “impression”) when the ad provider sends the digital ad to a client browser that will construct a webpage including the digital ad. Because a user may perform actions such as requesting a new webpage or closing a client browser before the user receives and/or views a digital ad, it is possible that an ad provider may record a digital ad as being viewed that is never actually viewed by the user. In an effort to address this problem, ad providers have developed systems for recording a digital ad as being viewed after the digital ad is rendered on a webpage displayed to a user. These systems are generally known as Client-Side Counting (“CSC”) systems. Examples of CSC systems and methods are disclosed in U.S. patent application Ser. No. 11/372,878, filed Mar. 10, 2006, and U.S. patent application Ser. No. 11/475,371, filed Jun. 26, 2006, both of which are assigned to Yahoo! Inc. One problem with CSC systems is verifying that communications, such as CSC beacon requests, sent from a client browser to an ad provider indicating a digital ad has been rendered on a webpage displayed to users are valid.

Similar fraud detection problems occur when an ad provider serves a digital ad that has been sold on a performance basis. Digital ads, such as graphical banner ads or sponsored search listings, are typically sold on a performance basis when an advertiser agrees to compensate an ad provider each time a user performs an action such as clicking-through a digital ad of the advertiser served by the ad provider. Thus, in order to accurately record when a user clicks-through a digital ad, it is necessary to determine when information sent from a client browser indicating a user navigation event such as a click-through is valid.

Accordingly, it is desirable to develop improved systems and methods for determining whether information from a client browser indicated events such as a digital ad impression or a click-through on a digital ad are valid.

### BRIEF DESCRIPTION OF THE DRAWINGS

FIG. 1 is a diagram of a toolbar running in conjunction with an Internet browser;

FIG. 2 is a block diagram of one embodiment of an environment in which systems for using a browser extension to detect events related to digital ads may operate;

FIG. 3 is a block diagram of one embodiment of system for using a browser extension to detect events related to digital ads; and

FIG. 4 is a block diagram of one embodiment of a method for using a browser extension to detect events related to digital ads.

### DETAILED DESCRIPTION OF THE DRAWINGS

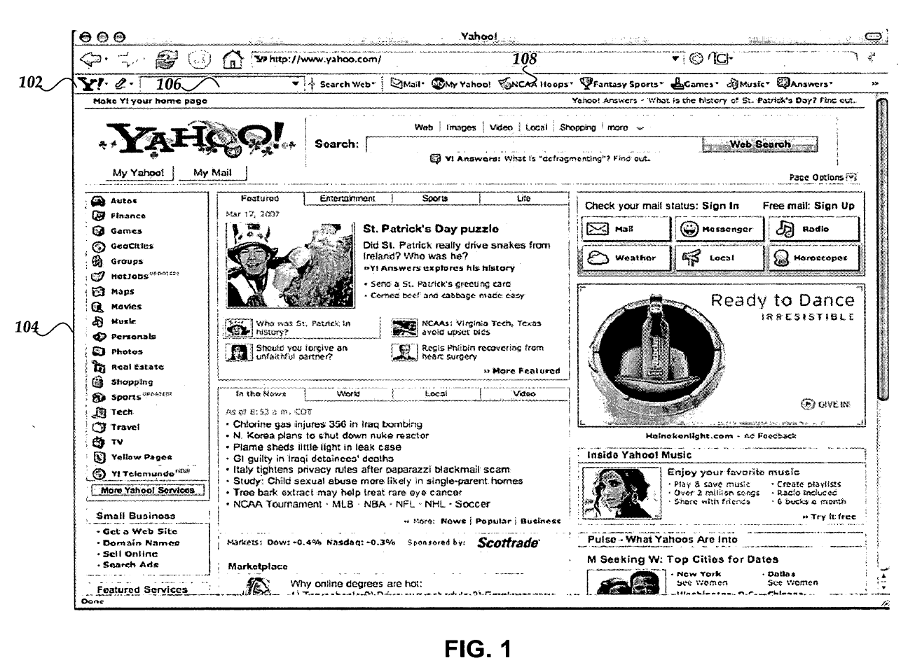

The present disclosure is directed to systems and methods for using a browser extension such as a toolbar to detect events related to digital ads. Generally, a browser extension is a piece of code that extends the functionality of a primary application. One example of a browser extension is a toolbar that runs in conjunction with an Internet browser to create a toolbar graphical user interface within a larger graphical user interface of the Internet browser. As shown in FIG. 1, examples of toolbars include the Yahoo!™ Toolbar 102 which runs in conjunction with Internet browsers such as Microsoft™ Internet Explorer or Mozilla™ Firefox 104. Typically, the toolbar graphical user interface 102 provides various areas for a user to interact with the toolbar, such as button or text windows, so that the user may quickly and easily perform actions within the primary application. For example, for a toolbar of an Internet browser, the toolbar 102 may provide a field 106 to submit a search query to a search engine, or buttons 108 to automatically redirect the Internet browser to a home page, or any other specific webpage.

Browser extensions such as toolbars 102 that run in conjunction with an Internet browser 104 are often able to observe and record events or actions occurring within the Internet browser 104. For example, the browser extension 102 may be able to detect what web pages a user visits, what hyperlinks a user clicks on, or any other information displayed in the Internet browser. As discussed in detail below, an ad provider may use a browser extension, such as a toolbar 102, running in conjunction with an Internet browser 104 running on a computer, server, mobile device, game console, or any other network device operative to run an Internet browser, to detect events such as a digital ad impression, a click-through on a digital ad, or an activation of a digital ad, and determine whether the detected event is valid.

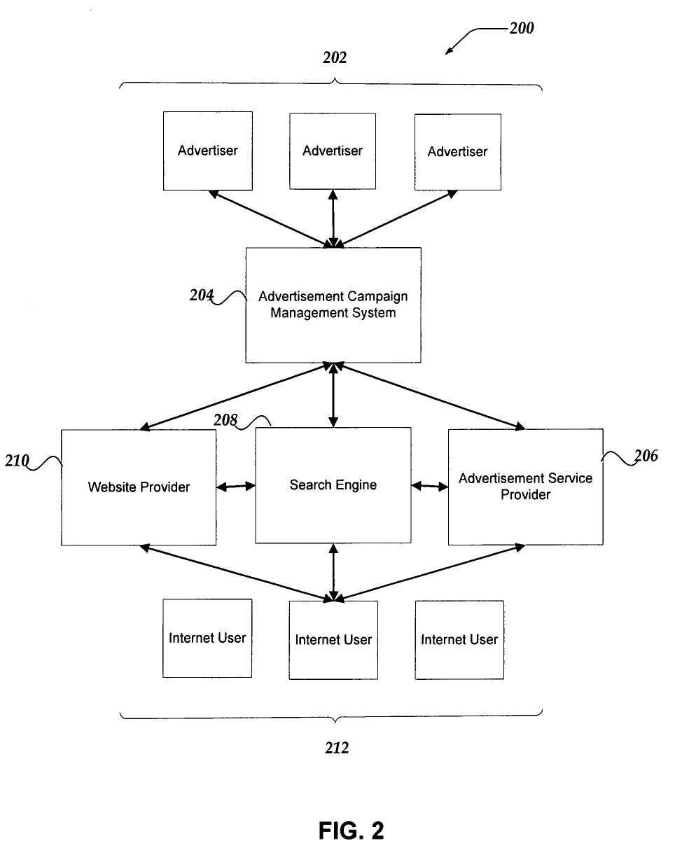

FIG. 2 is a block diagram of one embodiment of an environment in which a system for using a browser extension to detect events related to digital ads may operate. However, it should be appreciated that the systems and methods described below are not limited to use with a search engine or pay-for-placement online advertising.

The environment 200 may include a plurality of advertisers 202, an ad campaign management system 204, an ad provider 206, a search engine 208, a website provider 210, and a plurality of Internet users 212. Generally, an advertiser 202 bids on terms and creates one or more digital ads by interacting with the ad campaign management system 204 in communication with the ad provider 206. The advertisers 202 may purchase digital ads based on an auction model of buying ad space, or a guaranteed delivery model such as when an advertiser pays a minimum cost-per-thousand impressions (i.e., CPM) to display the digital ad. Typically, the advertisers 202 may pay additional premiums for certain targeting options, such as targeting by demographics, geography, technographics or context. The digital ad may be a graphical banner ad that appears on a website viewed by Internet users 212, a sponsored search listing that is served to an Internet user 212 in response to a search performed at a search engine, a video ad, a graphical banner ad based on a textual offer such as a sponsored search listing, and/or any other type of online marketing media known in the art.

When an Internet user 212 performs a search at a search engine 208, the ad provider 206 may serve one or more digital ads created using the ad campaign management system 204 to the Internet user 212 based on search terms provided by the Internet user 212. Also, when an Internet user 212 views a website served by the website provider 210, the ad provider 206 may serve one or more digital ads to the Internet user 212 based on keywords obtained from a website. When the digital ads are served, the ad campaign management system 204 and the ad provider 206 may record and process information associated with the served digital ads for purposes such as billing, reporting, or ad campaign optimization. For example, the ad campaign management system 204 and ad provider 206 may record the search terms that caused the ad provider 206 to serve the digital ads; whether the Internet user 212 clicked on a URL associated with the served digital ads; what additional digital ads the ad provider 206 served with the digital ad; a rank or position of a digital ad when the Internet user 212 clicked on the digital ad; and/or whether an Internet user 212 clicked on a URL associated with a different digital ad. One example of an ad campaign management system that may perform these types of actions is disclosed in U.S. patent application Ser. No. 11/413,514, filed Apr. 28, 2006, and assigned to Yahoo! Inc. It will be appreciated that the systems and methods for using a browser extension such as a toolbar to detect events related to digital ads described below may operate in the environment of FIG. 2.

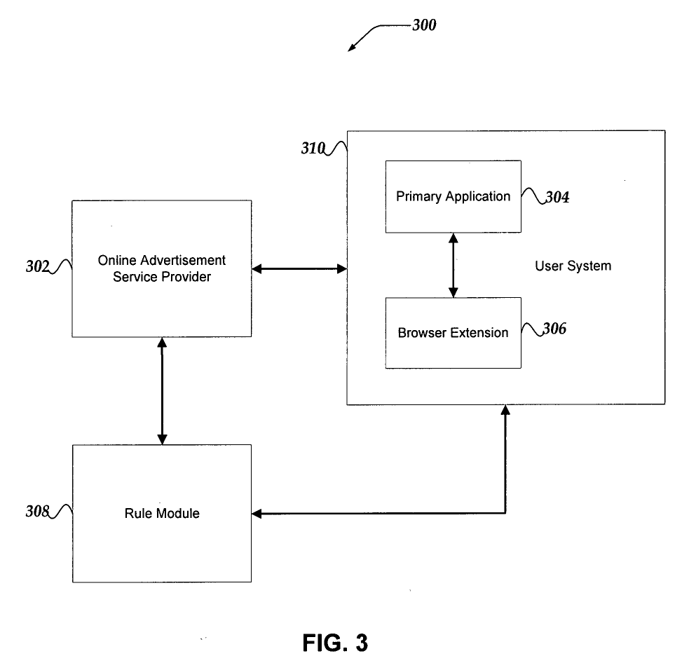

FIG. 3 is a block diagram of one embodiment of a system for using a browser extension such as a toolbar to detect events related to digital ads. Generally, the system 300 includes an ad provider 302, and an Internet browser 304 and a browser extension 306 such as a toolbar running in conjunction with a user system 310 that is operative to communicate with the ad provider 302 over one or more external networks. The ad provider 302 may be implemented as software code running in conjunction with a single server, a plurality of servers, or any other type of computing device known in the art. Similarly, the Internet browser 304 and browser extension 306 may be implemented as software code running in conjunction with a personal computer, a server, a mobile device, a game console, or any other type of computing device known in the art.

Generally, a user interacts with the Internet browser 304 and/or the browser extension 306 running in conjunction with the Internet browser 304. The user may perform actions such as requesting a webpage or submitting a search query to a search engine. Based on content in a requested webpage, or keywords in a submitted search query, the ad provider 302 serves one or more digital ads to the user that are displayed in the Internet browser 304.

While the user interacts with the Internet browser 304 and/or browser extension 306, the browser extension 306 monitors events regarding the Internet browser 304 and/or browser extension 306. For example, the browser extension 306 may detect events such as web pages requested by a user; digital ads received by the Internet browser 304; CSC beacon requests sent from the Internet browser 304; user navigation events such as a user clicking on a hyperlink associated with a digital ad or activating a digital ad; or any other event or action occurring within the Internet browser 304 and/or browser extension 306.

After detecting an event such as an Internet browser 304 sending a CSC beacon request to the ad provider 302, or a user clicking a hyperlink associated with a digital ad, the browser extension 306 may determine whether the detected event is valid, and report whether the detected event is valid to the ad provider 302. In one implementation, the browser extension 306 may determine whether an event is valid based on rules stored in a rule module 308 located at the user system 310 or distinct from the user system 310 such as at the ad provider 302. For example, the browser extension 306 may determine based on rules stored in the rule module 308 whether a user accidentally or intentionally double-clicks on a digital ad so that only a single click event is counted. Similarly, based on rules stored in the rule module 308, the browser extension may disregard a view event if the digital ad is never scrolled into view or the user refreshes the page and sees the same ad more than once.

Once the browser extension 306 determines the validity of the event, the browser extension 306 communicates the determined validity of the event to the ad provider 302. The browser extension 306 may communicate whether each event is valid to the ad provider 302, only communicate invalid events to the ad provider 302, only communicate valid events to the ad provider 302, or any combination thereof. Additionally, the browser extension 306 may communicate the determined validity of an event to the ad provider 302 as the validity of the event is determined, or the browser extension 306 may cache the determined validity of a number of events before communicating with the ad provider 302. For example, in one implementation, the browser extension 306 may communicate the determined validity of ten events to the ad provider 302, but the browser extension 306 may be programmed to communicate any number of events to the ad provider 302 at one time.

After receiving the determined validity of events, the ad provider 302 processes the events for purposes such as billing, reporting, or campaign optimization. In some implementations, the ad provider 302 uses the determined validity of events to double-check against other records of events. For example, in CSC systems, the ad provider 302 may check the determined validity of CSC beacon requests as determined by the browser extension 306 with records of the validity of CSC beacon requests as determined by the ad provider 302. Similarly, with respect to digital ads sold to a performance basis, the ad provider 302 may check the determined validity of a click-through on a hyperlink associated with a digital ad as determined by the browser extension 306 with records of the determined validity of a click-through on the hyperlink associated with the digital ad as determined by the ad provider 302. However, in other implementations, the ad provider 302 uses the determined validity of events as determined by the browser extension 306 to perform actions such as billing, reporting, or campaign irrespective of the determined validity of events as determined by the ad provider 302.

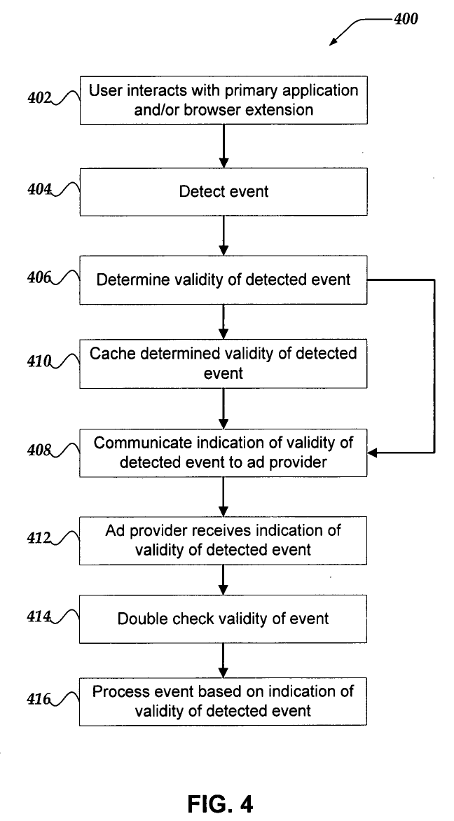

FIG. 4 is a flow chart of one embodiment of a method for using a browser extension such as a toolbar to detect events related to digital ads. The method 400 begins with a user interacting with an Internet browser and/or a browser extension running in conjunction with the Internet browser at block 402. The browser extension detects an event occurring within the Internet browser and/or browser extension at block 404. As discussed above, the event may be the Internet browser receiving one or more digital ads; one or more CSC beacon requests sent from an Internet browser to an ad provider; a user navigation event such as a user clicking on a hyperlink associated with a digital ad or activating a digital ad; or any other event or action occurring within the Internet browser and/or browser extension.

The browser extension determines the validity of the detected event at block 406 based on or more rules stored in a rule module in communication with the browser extension. The browser extension then sends an indication of the determined validity of the detected event to the ad provider at block 408. As described above, in some implementations the browser extension communicates the determined validity of the event to the ad provider regardless of whether the event is determined to be valid or invalid. However, in other implementations, the browser extension only communicates events to the ad provider that are determined to be valid, or only communicates events to the ad provider that are determined to be invalid.

Further, in some implementations, rather than communicating the determined validity of the event to the ad provider immediately after block 406, the browser extension may cache the determined validity of the event at block 410. After a predetermined number of events have been cached, the browser extension then communicates all of the cached determined validities to the ad provider at block 408.

The ad provider receives the determined validity of the event at block 412. In some implementations, at block 414, the ad provider may double check the validity of the event as determined by the browser extension with the validity of the event as determined by the ad provider for purposes of billing, report, or campaign optimization. In other implementations, at block 416, the ad provider processes the received determination of validity of the events irrespective of the validity of the events as determined by the ad provider.

FIGS. 1-4 disclose systems and methods for using a browser extension such as a toolbar to detect events related to digital ads. It will be appreciated that by monitoring activity directly on user systems, a browser extension may be able to more accurately determine the validity of events such as an Internet browser receiving one or more digital ads; one or more CSC beacon requests sent from an Internet browser to an ad provider; a user navigation event such as a user clicking on a hyperlink associated with a digital ad or activating a digital ad; or any other event or action occurring within the Internet browser and/or browser extension. Further, because a browser extension may only communicate events that are determined to be valid to the ad provider, the browser extension may reduce the amount of traffic to an ad provider. Moreover, a browser extension determining a validity of an event provides the ad provider with a system to double check a validity of the same event as determined by the ad provider.

It is therefore intended that the foregoing detailed description be regarded as illustrative rather than limiting, and that it be understood that it is the following claims, including all equivalents, that are intended to define the spirit and scope of this invention.

1. A method for detecting events related to a digital ad, the method comprising:
detecting an event related to a digital ad with a browser extension running in conjunction with a primary application;
determining a validity of the detected event with the browser extension; and
communicating an indication of the determined validity of the detected event from the browser extension to a remotely located online advertisement service provider.

2. The method of claim 1, wherein the browser extension is a toolbar.

3. The method of claim 1, wherein the primary application is an Internet browser.

4. The method of claim 1, wherein the browser extension and primary application are running on a personal computer.

5. The method of claim 1, wherein the browser extension and primary application are running on a mobile device.

6. The method of claim 1, wherein the digital ad is a graphical banner ad.

7. The method of claim 1, wherein the digital ad is a sponsored search listing.

8. The method of claim 1, wherein the digital ad is a graphical banner ad based on a textual offer.

9. The method of claim 1, wherein the event comprises the primary application receiving one or more digital ads.

10. The method of claim 1, wherein the event comprises the primary application sending one or more client-side counting beacon requests to the online advertisement service provider.

11. The method of claim 1, wherein the event comprises a user clicking on a hyperlink associated with a digital ad.

12. A computer-readable storage medium comprising a set of instructions for detecting events related to a digital ad, the set of instructions to direct a processor to perform acts of:
detecting an event related to a digital ad with a browser extension running in conjunction with a primary application;
determining a validity of the detected event with the browser extension; and
communicating an indication of the determined validity of the detected event form the browser extension to a remotely located online advertisement service provider.

13. The computer-readable storage medium of claim 12, wherein the browser extension is a toolbar.

14. The computer-readable storage medium of claim 12, wherein the primary application is an Internet browser.

15. The computer-readable storage medium of claim 12, wherein the event comprises the primary application sending one or more client-side counting beacon requests to the online advertisement service provider.

16. The computer-readable storage medium of claim 12, wherein the event comprises a user clicking on a hyperlink associated with a digital ad.

17. A system for detecting events related to a digital ad, the system comprising:
a browser extension running in conjunction with a primary application, the browser extension operative to detect an event related to a digital ad, to determine a validity of the detected event, and to communicate an indication of the determined validity of the detected event to a remotely located online advertisement service provider.

18. The system of claim 17, wherein the browser extension is a toolbar.

19. The system of claim 17, wherein the primary application is an Internet browser.

20. The system of claim 17, wherein the online advertisement service provider is operative to compare the validity of the event as determined by the browser extension with a validity of the event as determined by the online advertisement service provider.

21. The system of claim 17, wherein the event comprises the primary application sending one or more client-side counting beacon requests to the online advertisement service provider.

22. The system of claim 17, wherein the event comprises a user clicking on a hyperlink associated with a digital ad.
